(19) United States
(12) Patent Application Publication
(10) Pub. No.: US 2014/0034881 A1
(43) Pub. Date: Feb. 6, 2014

(54) CARBON NANOTUBE-RADICAL POLYMER COMPOSITE AND PRODUCTION METHOD THEREFOR

(71) Applicants: Kurt E. Geckeler, Gwangju (KR); Hiroyuki Nishide, Gwangju (KR); Seok Ju Choi, Gwangju (KR); Wonsung Choi, Gwangju (KR)

(72) Inventors: Kurt E. Geckeler, Gwangju (KR); Hiroyuki Nishide, Gwangju (KR); Seok Ju Choi, Gwangju (KR); Wonsung Choi, Gwangju (KR)

(73) Assignee: Gwangju Institute of Science and Technology, Gwangju (KR)

(21) Appl. No.: 13/984,369

(22) PCT Filed: Dec. 12, 2011
(86) PCT No.: PCT/KR11/09552

§ 371 Date: Oct. 16, 2013

(30) Foreign Application Priority Data
Feb. 8, 2011 (KR) 10-2011-0011073

(51) Int. Cl. H01B 1/24

(52) U.S. Cl. CPC H01B 1/24
USPC 252/511

(57) ABSTRACT

The present invention relates to a carbon nanotube-radical polymer composite and to a production method therefor, and relates to a polymer composite comprising carbon nanotubes and a radical polymer; being a carbon nanotube-radical polymer composite that has outstanding electrical conductivity and transparency and can be used in permeable batteries or flexible batteries, and also relates to a production method therefor.

### TECHNICAL FIELD

The present invention relates to a carbon nanotube-radical polymer composite and a method of preparing the same, and more particularly, to a carbon nanotube-radical polymer composite capable of being used in a transmissive battery or a flexible battery due to its excellent electrical conductivity and transparency as a polymer composite composed of a carbon nanotube and a radical polymer, and a method of preparing the same.

### BACKGROUND ART

A carbon nanotube, which is a material having a long carbon structure in a honeycomb shape and a cylindrical diameter of only several tens nanometer (nanometer is one-billionth of a meter) and formed in a pipe shape by connecting hexagons composed of 6 carbons with each other, has properties such as electrical conductivity similar to that of copper, thermal conductivity equal to that of diamond, and strength 100 times stronger than that of steel.

The carbon nanotube, which is a material accidentally discovered by Ijima Sumio of the Japanese NEC Corporation in 1991 during a process of investigating a structure of carbon, is a long honeycomb tube having a diameter of only ten-thousandth of that of a hair and has excellent electromechanical properties, such that the carbon nanotube has been researched as a material for a new generation semiconductor.

The carbon nanotube has been used as a component of various composite materials. In addition, due to its multi-functionality caused by a specific structure and physical properties, for example, high electric conductivity, thermal stability, and mechanical strength, the carbon nanotube has excellent appliances to a flat panel display, which is essential device for an information and communication apparatus, a highly integrated memory device, a secondary battery and an ultra-high capacity capacitor, a hydrogen storage material, a chemical sensor, a high strength/ultra-light weight composite material, a static electricity removing composite material, an electromagnetic wave shielding material, and the like, and is likely to overcome a limitation in the existing device, such that various researches into the carbon nanotube have been conducted.

However, since the carbon nanotube has a low dispersion degree in a polymer raw material due to a long length thereof and coagulation by van der Waals force, there were problems in application and productivity thereof. Further, since the carbon nano-tube is black, there was a limitation in applying the carbon nano-tube to a transparent battery, or the like.

Therefore, in order to solve the problems as described above, research into a technology of applying the carbon nanotube to various fields using the potentiality of the carbon nanotube has been demanded.

### DISCLOSURE

### Technical Problem

An object of the present invention is to provide a carbon nanotube-radical polymer composite having flexibility, high electrical conductivity, a high current rate, and high transparency as a composite composed of a carbon nanotube forming a percolation network at a low loading rate and a radical polymer exhibiting high transparency by mixing the carbon nanotube with a radical polymer having at least one nitroxide moiety using ultrasonication and ultracentrifugation to prepare the polymer composite.

### Technical Solution

In one general aspect, a carbon nanotube-radical polymer composite contains a carbon nanotube and a radical polymer, and a method of preparing the same.

The carbon nanotube may include at least one kind selected from a single walled carbon tube, a double walled carbon tube, or a multi walled carbon tube that has a fibrous shape with a diameter of a nano size, a carbon fiber, and a carbon horn.

The radical polymer may include at least one nitroxide moiety represented by the following Chemical Formula 1.

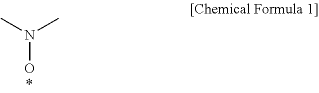

As the radical polymer, at least one kind selected from compounds represented by the following Chemical Formulas 2 to 7 may be used.

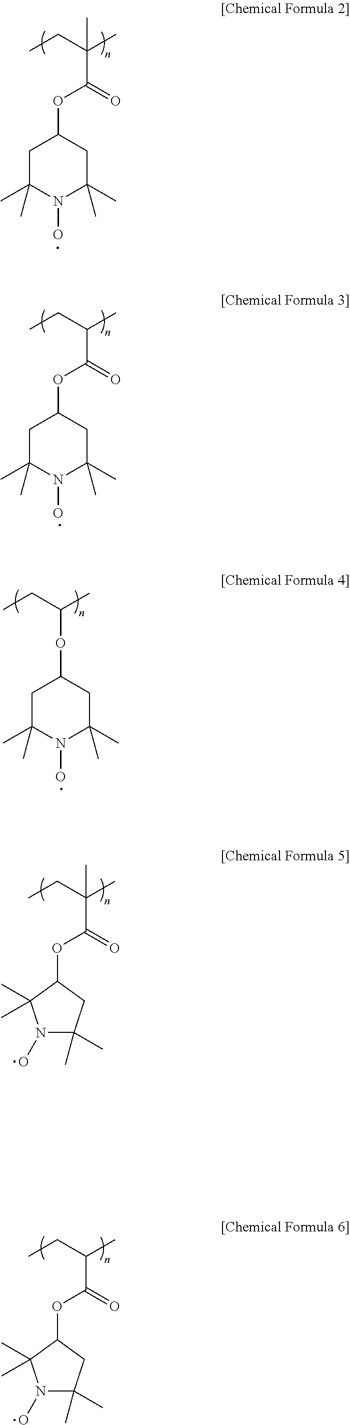

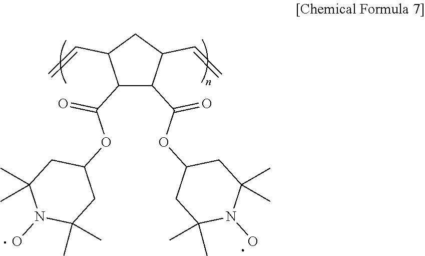

The radical polymer may be poly(2,2,6,6-tetramethylpiperidinyloxy-4-yl methacrylate (PTMA).

The carbon nanotube-radical polymer composite may be composed of 1 to 20 weight % of the carbon nanotube and 80 to 99 weight % of radical polymer.

In another general aspect, a method of preparing a carbon nanotube-radical polymer composite, the method includes:

(1) adding a carbon nanotube in an organic solvent and dispersing the carbon nanotube using ultrasonication and ultracentrifugation to prepare a dispersion solution; and

(2) adding the dispersion solution to a radical polymer solution and performing ultrasonication to prepare a carbon nanotube-radical polymer composite.

The organic solvent may be at least one kind selected from o-dichlorobenzene, benzene, dimethylformamide (DMF), monochlorobenzene, and N-methylpyrrolidone.

A content of the organic solvent may be 100 to 500 parts by weight based on 100 parts by weight of the carbon nanotube.

The radical polymer solution may contain 30 to 500 parts by weight of an organic solvent based on the 100 parts by weight of the radical polymer.

The radical polymer may include at least one nitroxide moiety represented by the following Chemical Formula 1.

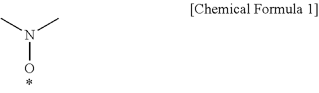

As the radical polymer, at least one kind selected from compounds represented by the following Chemical Formulas 2 to 7 may be used.

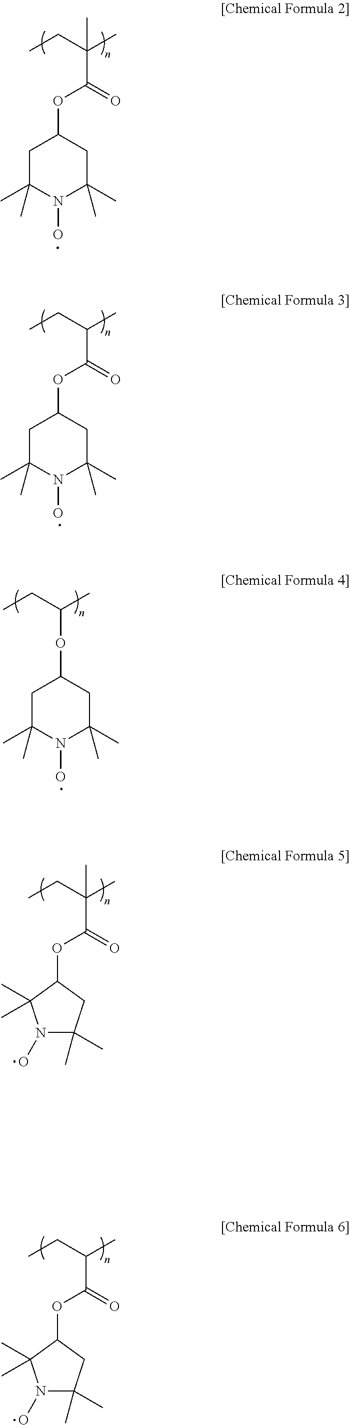

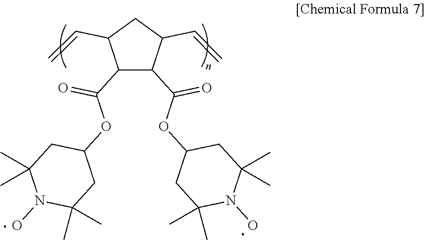

The radical polymer may be poly(2,2,6,6-tetramethylpiperidinyloxy-4-yl methacrylate (PTMA).

The carbon nanotube-radical polymer composite may be composed of 1 to 20 weight % of the carbon nanotube and 80 to 99 weight % of radical polymer.

The dispersion in step (1) may be performed using ultrasonication at 0 to 30° C. for 30 minutes to 2 hours and ultracentrifugation at 13,000 to 19,000 g for 20 minutes to 1 hour after adding the carbon nanotube in the organic solvent.

Step (2) may be performed by adding the dispersion solution to the radical polymer solution and performing ultrasonication at 0 to 30° C. for 1 to 10 minutes.

### Advantageous Effects

With a carbon nanotube-radical polymer composite and a method of preparing the same according to the present invention, the carbon nanotube-radical polymer composite has flexibility, improved electrical conductivity, and high current rate and transparency by forming the carbon nanotube-radical polymer composite based on a network of a carbon nanotube and a radical polymer, such that the carbon nanotube-radical polymer composite may be applied to a flexible battery having high charging and discharging performance as a thick film and a transparent battery used in a transparent window and be expected to be industrially applied as a new raw material capable of overcoming limitations of the existing material in various fields such as a sensor, a nanoelectron device, an electrochromic device, a solar cell, and the like.

### DESCRIPTION OF DRAWINGS

FIG. 1 is a view showing a carbon nanotube-radical polymer composite according to the present invention. In FIG. 1, reference number 1 indicates a carbon nanotube, reference number 2 indicates a radical polymer, and reference number 3 indicates a current supplying plate. The carbon nanotube 1 is enclosed by the radical polymer 2 by van der Waals interaction to thereby be dissolved in an organic solvent, for example, chloroform.

FIGS. 2A and 2B are graphs showing discharge curves of the carbon nanotube-radical polymer composite according to the present invention and a radical polymer, respectively. FIGS. 2A and 2B show that an electrode made of the carbon nanotube-radical polymer composite according to the present invention has a speed performance higher than that of an electrode made of the radical polymer, and in the case of using the carbon nanotube-radical polymer composite according to the present invention, 72% of the total capacity may be charged within 10 minutes. The curves in FIG. 2A indicates 10 C, 30 C, 100 C, 300 C, and 600 C from the left, respectively, wherein 1 C means that discharge is completed within 1 hour, and 2 C means that the discharge is completed within 30 minutes.

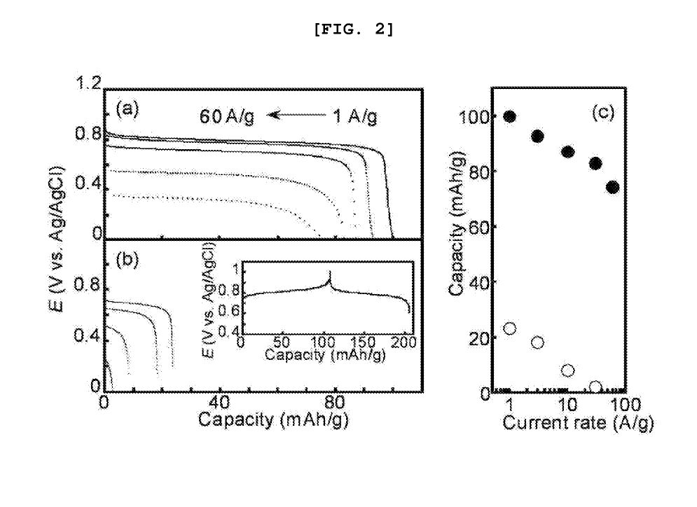

In addition, in FIG. 2C, means the carbon nanotube-radical polymer composite, and ◯ means the radical polymer, and it may be appreciated that the carbon nanotube-radical polymer composite according to the present invention has capacity higher than that of the radical polymer.

### BEST MODE

In the present invention, it was confirmed that a carbon nanotube-radical polymer composite had excellent electro-chemical properties and high transparency by preparing the carbon nanotube-radical polymer composite containing a carbon nanotube and a radical polymer.

The carbon nanotube-radical polymer composite according to the present invention is characterized by containing the carbon nanotube and a radical polymer including at least one nitroxide moiety represented by the following Chemical Formula 1.

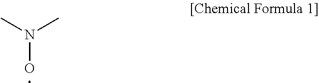

The carbon nanotube used in the present invention is a material having excellent properties such as high electrical conductivity and formation of a percolation network at a low loading rate to thereby be used appropriately for a current supply plate in a battery, and a carbon nanotube specialized by a micro-scale structure may be mixed with the radical polymer to thereby increase charge distribution. The carbon nanotube may be well dispersed in the radical polymers having high electrical conductivity. Therefore, the carbon nanotube may disperse electrons in the radical polymer due to high electrical conductivity of the carbon nanotube. The carbon nanotube may be infiltrated into an electrolyte.

Further, this carbon nanotube is mixed with the radical polymer as a conductive particle to form the polymer composite and impart conductivity. Since the composite imparted with conductivity has an electromagnetic wave shielding property and is easily processed, the composite may be applied to various fields such as a mobile phone case. In addition, mechanical strength of the composite containing the carbon nanotube may be improved.

As the carbon nanotube, at least one kind selected from a single walled carbon tube, a double walled carbon tube, or a multi walled carbon tube that has a fibrous shape with a diameter of a nano size, a carbon fiber, a carbon horn, and the like, may be used.

The carbon nanotube may be a carbon nanotube available in the market, and as needed, be obtained by additionally drying and/or purifying the carbon nanotube available in the market.

The radical polymer used in the present invention may be applied as a cathode active material generally made of a radical polymer in a radical battery composed of a cathode, an electrical conductive carbon fiber, and a current supply plate. In addition, the radical polymer is used in order to overcome disadvantages of the carbon nanotube. An theoretical capacity based on an atomic weight in a battery using a composite composed of a relatively high carbon composition containing 80 weight % of carbon fiber may correspond to that of a general radical battery. However, in this case, since a large amount of carbon fiber is contained, all of the electrodes made of this composite become black, thereby limiting advantages of a radical polymer for a transparent battery. Therefore, the carbon nanotube has high electrical conductivity, but it is difficult to use the carbon nanotube as a transmissive material due to the color thereof. Therefore, the carbon nanotube may be used in the transmissive battery by adding the radical polymer used in the present invention to thereby become transparent.

As the radical polymer used in the present invention, any radical polymer may be used as long as the radical polymer is a compound containing at least one nitroxide moiety. For example, at least one kind selected from compounds represented by the following Chemical Formulas 2 to 7.

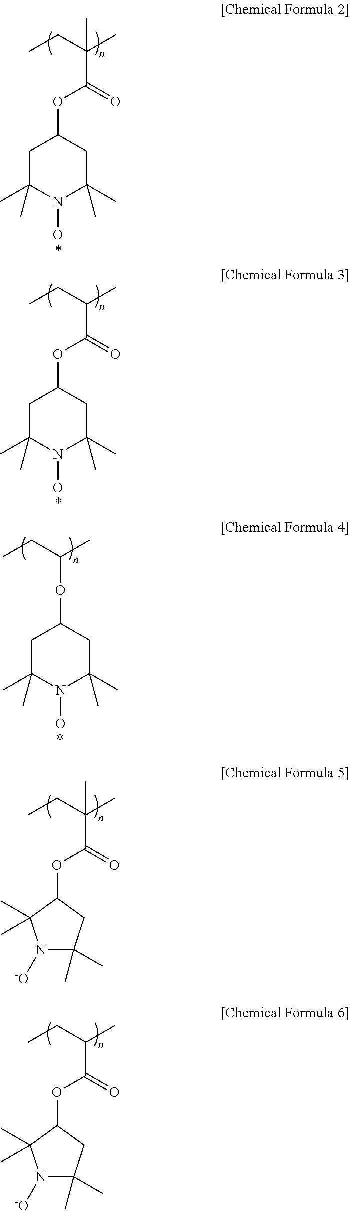

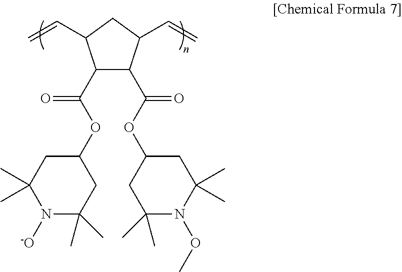

The radical polymer may be preferably poly(2,2,6,6-tetramethylpiperidinyloxy-4-yl methacrylate) (PTMA), and the reason is that a structure of PTMA is most suitable for enclosing the carbon nanotube.

The carbon nanotube-radical polymer composite according to the present invention may be composed of 1 to 20 weight % of the carbon nanotube and 80 to 99 weight % of the radical polymer. In the case in which a content of the carbon nanotube is lower than 1 weight % or a content of the radical polymer is higher than 99 weight %, connection portions between the carbon nanotubes are small, such that electrical conductivity of the composite may be decreased, and in the case in which the content of the radical polymer is lower than 80 weight % or the content of the carbon nanotube is higher than 20 weight %, a dispersion property of the carbon nanotube is decreased, which may deteriorate the entire physical properties of the composite, and a large amount of carbon nanotube is contained, which may decrease transparency.

A method of preparing a carbon nanotube-radical polymer composite according to the present invention includes:

(1) adding a carbon nanotube in an organic solvent and dispersing the carbon nanotube using ultrasonication and ultracentrifugation to prepare a dispersion solution; and

(2) adding the dispersion solution to a radical polymer solution and performing ultrasonication to prepare a carbon nanotube-radical polymer composite.

A kind of carbon nanotube is not particularly limited. For example, the carbon nanotube may be at least one kind selected from a single walled carbon tube, a double walled carbon tube, or a multi walled carbon tube that has a fibrous shape, a carbon fiber, a carbon horn, and the like. Alternatively, the carbon nanotube may be a carbon nanotube available in the market or obtained by additionally drying and/or purifying the carbon nanotube available in the market, as needed.

A kind of organic solvent is not particularly limited. For example, the organic solvent may be at least one kind selected from o-dichlorobenzene, benzene, dimethylformamide (DMF), monochlorobenzene, N-methylpyrrolidone, and the like. In addition, a mixing ratio is not particularly limited. For example, the mixing ratio may be 1:9 to 9:1.

A content of the organic solvent may be preferably 100 to 500 parts by weight based on 100 parts by weight of the carbon nanotube. In the case in which the content is out of the above-mentioned range, the carbon nanotube may not be appropriately dispersed.

The radical polymer solution may preferably contain 30 to 500 parts by weight of an organic solvent based on the 100 parts by weight of the radical polymer, wherein a kind of organic solvent is not particularly limited. For example, the organic solvent may be at least one kind selected from o-dichlorobenzene, benzene, DMF, monochlorobenzene, N-methylpyrrolidone, and the like. In addition, a mixing ratio is not particularly limited. For example, the mixing ratio may be 1:9 to 9:1.

The radical polymer may include at least one nitroxide moiety represented by the following Chemical Formula 1.

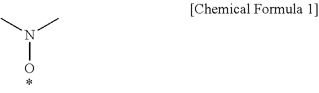

More specifically, as the radical polymer, at least one kind selected from the compounds represented by the following Chemical Formulas 2 to 7 may be used.

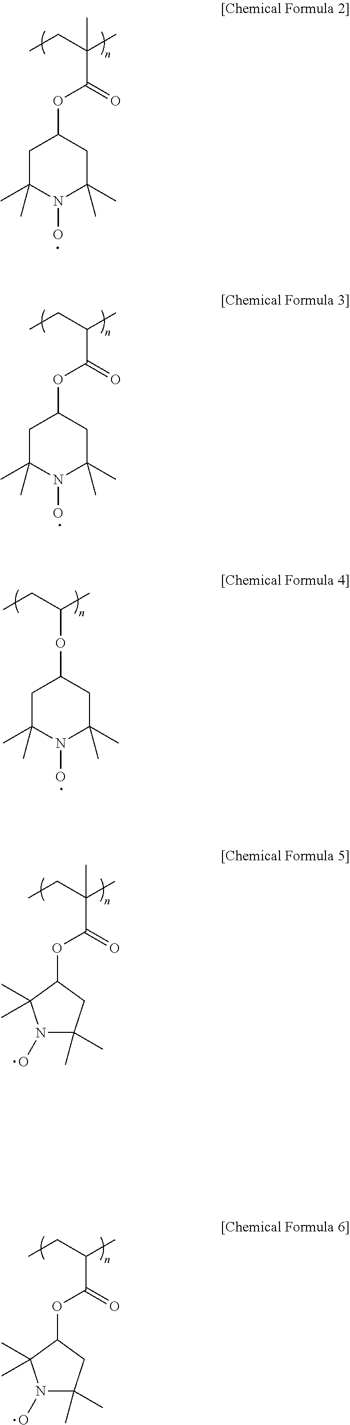

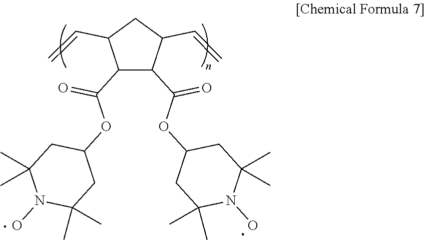

The carbon nanotube-radical polymer composite according to the present invention may be composed of 1 to 20 weight % of the carbon nanotube and 80 to 99 weight % of the radical polymer, but is not particularly limited thereto.

Step (1) may be preferably performed by adding the carbon nanotube to the organic solvent and then using ultrasonication at 0 to 30° C. for 30 minutes to 2 hours and ultracentrifugation at 13,000 to 19,000 g for 20 minutes to 1 hour. When the above-mentioned ranges are not satisfied, the dispersion may not be appropriately performed.

Step (2) may be preferably performed by adding the dispersion solution to the radical polymer solution and performing ultrasonication at 0 to 30° C. for 1 to 10 minutes. When the above-mentioned ranges are not satisfied, it may be difficult to maintain stability of the polymer itself.

The carbon nanotube-radical polymer composite according to the present invention has excellent electrical conductivity and transparency, such that the carbon nanotube-radical polymer may be applied to a transparent battery capable of being used in a transparent window.

Hereinafter, in order to assist in understanding of the present invention, a preferable Example is described. However, the following Example is provided only for easily understanding the present invention. Therefore, the present invention is not limited thereto.

### EXAMPLE 1 AND COMPARATIVE EXAMPLES 1 AND 2

### Example 1

5 mg of a single walled carbon nanotube (SWNT, product name: BU-202, manufacturer: Bucky USA) was ultrasonicated in o-dichlorobenzene (DCB, 10 ml) in an ice bath for 40 minutes, thereby obtaining a SWNT dispersion solution. The dispersion solution was centrifuged at 16,000 for 30 minutes. The supernatant (0.5 ml) was added to a DCB solution (3 ml) containing 5 mg of poly(2,2,6,6-tetramethylpiperidinyloxy-4-yl methacrylate. After the mixture was further ultrasonicated for 5 minutes, the final mixture (0.5 ml) was drop-casted onto an indium tin oxide (ITO) substrate at an area of 1.5 to 2.5 cm² and dried at 50° C. in a vacuum oven to form a carbon nanotube-radical polymer composite film. Then, transparency and electric conductivity of the composite film were measured, and the results were shown in the following Table 1.

### Comparative Example 1

A composite film was manufactured by the same method as in Example 1 except for using 0.005 mg of the SWNT, and then the transparency and electric conductivity thereof were measured. The results were shown in the following Table 1.

### Comparative Example 2

A composite film was manufactured by the same method as in Example 1 except for using 30 mg of the SWNT, and then the transparency and electric conductivity thereof were measured. The results were shown in the following Table 1.

TABLE 1

| | | Comparative | Comparative |
|---|---|---|---|
| | Example 1 | Example 1 | Example 2 |
| Transparency | 80% | 86% | 72% |
| (%)¹⁾ | | | |
| Electrical | 1 | 0.7 | 1.3 |
| conductivity | | | |
| (S/cm)²⁾ | | | |

Note
¹⁾measured by UV-visible spectroscopy.
Note
²⁾measured by a 4-probe method.

As shown in Table 1, it may be appreciated that in the case of Example 1, electric conductivity and transparency were high, such that the composite of Example 1 may be applied to a transparent battery. However, in the case of Comparative Example 1, an amount of carbon nanotube was excessively small, such that transparency was high but electric conductivity was significantly decreased, and in the case of Comparative Example 2, a large amount of carbon nanotube was added, such that electrical conductivity was improved, but transparency was 72%. Therefore, the composite of Comparative Example 2 may be inappropriate for being used in a transparent battery.

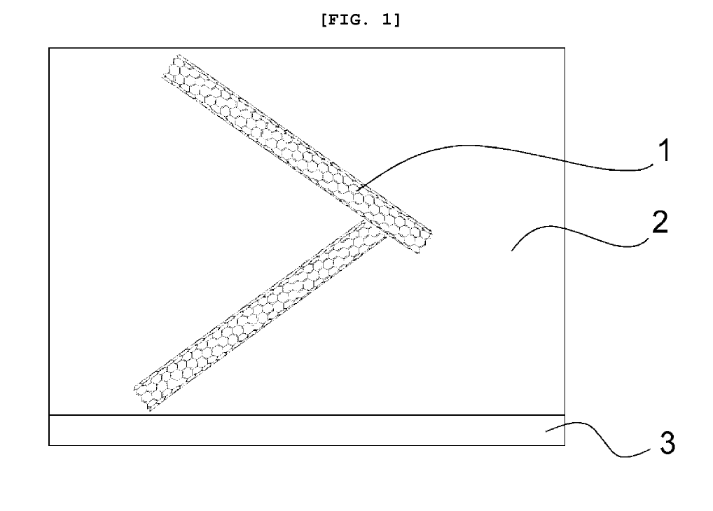

Referring to FIG. 1, it may be appreciated that the carbon nanotube-radical polymer composite of Example 1 was appropriately dispersed in a matrix without being surfaced or precipitated during an annealing and drying process. In Example 1, the transparency was 80% or more at 550 nm. Further, the composite of Example 1 does not need to additionally add the carbon nanotube exhibiting black transparent appearance due to high transparency.

In addition, the composite of Example 1 has high transparency, such that the composite may be used in a battery capable of being applied to a transparent window. Therefore, the composite of Example 1 may be applied to an electrochromic device, a solar cell, and a transparent battery.

Further, in Example 1, preliminary conductivity showed a low threshold of 0.83%, a reversible reduction wave was shown at 0.78V, a half cell had a capacity of 99 mAh/g, and an theoretical capacity in a battery having a film thickness of 780 nm was 90% (111 mAh/g).

1. A carbon nanotube-radical polymer composite comprising a carbon nanotube and a radical polymer including at least one nitroxide moiety represented by the following Chemical Formula 1.

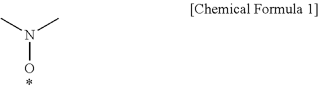

2. The carbon nanotube-radical polymer composite of claim 1, wherein the carbon nanotube is at least one kind selected from a single walled carbon tube, a double walled carbon tube, or a multi walled carbon tube that has a fibrous shape with a diameter of a nano size, a carbon fiber, and a carbon horn.

3. The carbon nanotube-radical polymer composite of claim 1, wherein the radical polymer is at least one selected from compounds represented by the following Chemical Formulas 2 to 7.

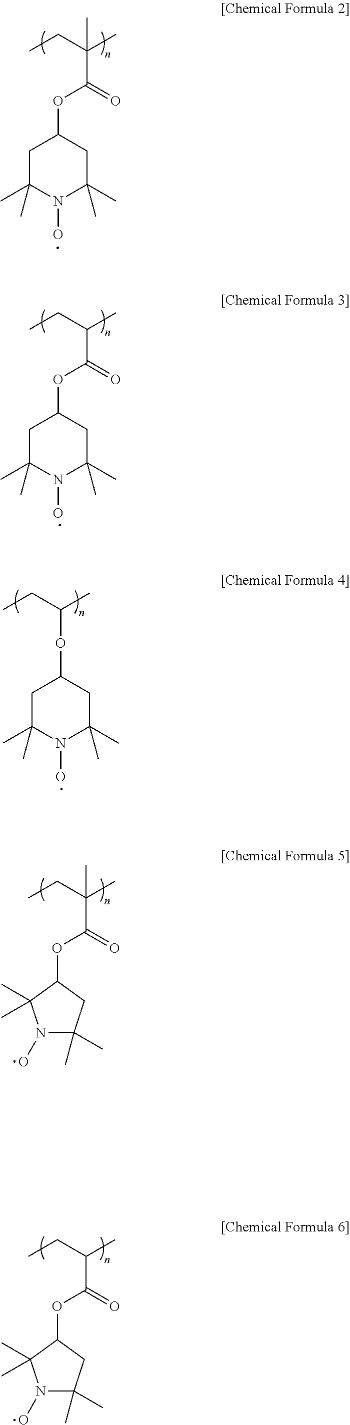

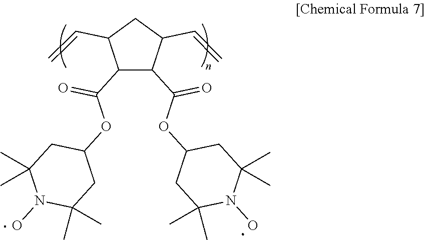

4. The carbon nanotube-radical polymer composite of claim 1, wherein the radical polymer is poly(2,2,6,6-tetramethylpiperidinyloxy-4-yl methacrylate (PTMA).

5. The carbon nanotube-radical polymer composite of claim 1, wherein it is composed of 1 to 20 weight % of the carbon nanotube and 80 to 99 weight % of radical polymer.

6. A method of preparing a carbon nanotube-radical polymer composite, the method comprising:
(1) adding a carbon nanotube in an organic solvent and dispersing the carbon nanotube using ultrasonication and ultracentrifugation to prepare a dispersion solution; and
(2) adding the dispersion solution to a radical polymer solution and performing ultrasonication to prepare a carbon nanotube-radical polymer composite.

7. The method of claim 6, wherein the carbon nanotube is at least one kind selected from a single walled carbon tube, a double walled carbon tube, or a multi walled carbon tube that has a fibrous shape with a diameter of a nano size, a carbon fiber, and a carbon horn.

8. The method of claim 6, wherein the organic solvent is at least one kind selected from o-dichlorobenzene, benzene, dimethylformamide (DMF), monochlorobenzene, and N-methylpyrrolidone.

9. The method of claim 8, wherein a content of the organic solvent is 100 to 500 parts by weight based on 100 parts by weight of the carbon nanotube.

10. The method of claim 6, wherein the radical polymer solution contains 30 to 500 parts by weight of an organic solvent based on the 100 parts by weight of the radical polymer, the organic solvent being at least one kind selected from o-dichlorobenzene, benzene, dimethylformamide (DMF), monochlorobenzene, and N-methylpyrrolidone.

11. The method of claim 10, wherein the radical polymer includes at least one nitroxide moiety represented by the following Chemical Formula 1.

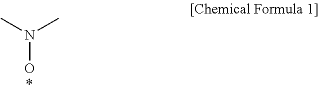

12. The method of claim 11, wherein the radical polymer is at least one kind selected from compounds represented by the following Chemical Formulas 2 to 7.

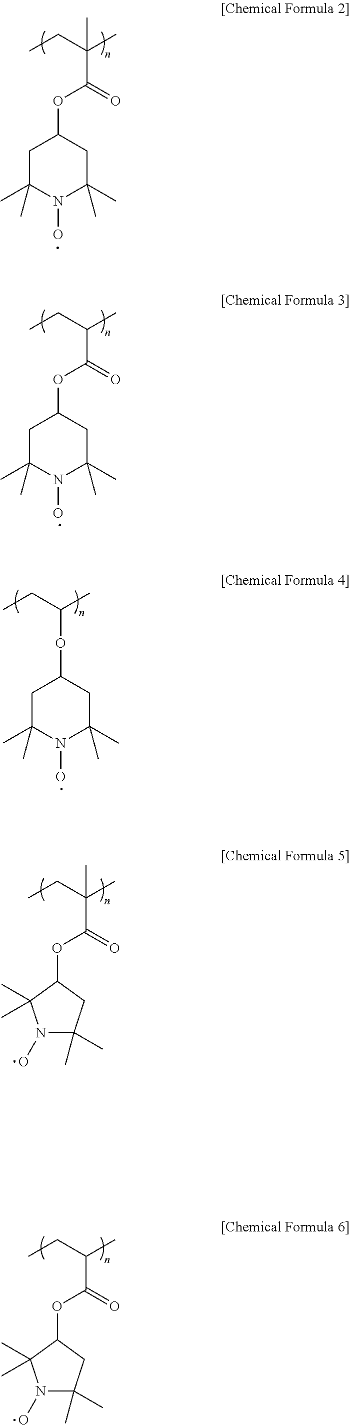

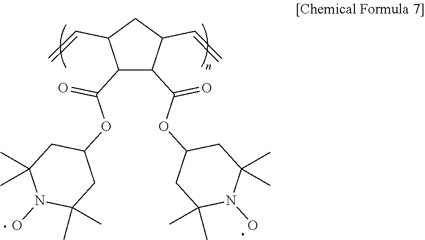

13. The method of claim 6, wherein the carbon nanotube-radical polymer composite is composed of 1 to 20 weight % of the carbon nanotube and 80 to 99 weight % of radical polymer.

14. The method of claim 6, wherein the dispersion in step (1) is performed using ultrasonication at 0 to 30° C. for 30 minutes to 2 hours and ultracentrifugation at 13,000 to 19,000 g for 20 minutes to 1 hour after adding the carbon nanotube in the organic solvent.

15. The method of claim 6, wherein step (2) is performed by adding the dispersion solution to the radical polymer solution and performing ultrasonication at 0 to 30° C. for 1 to 10 minutes.

16. A transparent battery manufactured by the method of claim 6.
